(19) United States
(12) Patent Application Publication
(10) Pub. No.: US 2014/0292633 A1
(43) Pub. Date: Oct. 2, 2014

(54) LIQUID CRYSTAL DISPLAY DEVICE AND DRIVING METHOD THEREOF

(71) Applicant: Panasonic Liquid Crystal Display Co., Ltd., Himeji-shi (JP)

(72) Inventors: Atsushi KIMURA, Hokkaido (JP); Nobumichi TAKABA, Hokkaido (JP)

(73) Assignee: Panasonic Liquid Crystal Display Co., Ltd., Himeji-shi (JP)

(21) Appl. No.: 14/199,486

(22) Filed: Mar. 6, 2014

(30) Foreign Application Priority Data
Mar. 29, 2013 (JP) 2013-071259

(51) Int. Cl. G09G 3/36

(52) U.S. Cl. CPC G09G 3/36
USPC 345/102

(57) ABSTRACT

Provided is a liquid crystal display device, including: a maximum signal detecting section for detecting a maximum signal having a signal level that is maximum among an R signal, a G signal, and a B signal included in an input video signal; a correction curve calculating section for calculating a correction curve based on backlight intensity; a signal correction value calculating section for calculating, based on the maximum signal and the correction curve, a signal correction value for correcting the input video signal; and a signal correcting section for correcting the input video signal based on the signal correction value.

### CROSS-REFERENCE TO RELATED APPLICATION

The present application claims priority from Japanese application JP2013-071259 filed on Mar. 29, 2013, the content of which is hereby incorporated by reference into this application.

### TECHNICAL FIELD

The present application relates to a liquid crystal display device, and more particularly, to a liquid crystal display device and a driving method therefor that are capable of reducing backlight intensity to achieve lower power consumption.

### BACKGROUND

Hitherto, there has been proposed a technology for achieving lower power consumption in a liquid crystal display device without impairing the visual brightness of a display screen by reducing backlight intensity and further increasing a luminance level of an input video signal (for example, see Japanese Patent Application Laid-open No. 2004-246099).

Japanese Patent Application Laid-open No. 2004-246099 discloses the following configuration. When a power saving mode of reducing the backlight intensity than usual is set, a backlight power supply is controlled to reduce the light intensity of a backlight module. Simultaneously, a video signal in an RGB mode is converted into a video signal in a YCbCr mode, and a luminance signal component Y is enhanced and then inversely converted into a video signal in an RGB mode. The video signal having the enhanced luminance signal component is output to an LCD module.

### SUMMARY

However, in the technology of Japanese Patent Application Laid-open No. 2004-246099, merely a Y signal corresponding to the luminance signal component is corrected (enhanced) in the video signal in a YCbCr mode. Therefore, although visual brightness of the display screen can be maintained, there arises a problem in that the ratio between the Y signal (luminance component) and the C signal (chrominance component) changes to change the saturation (visual hue).

The present invention has been made in view of the above-mentioned problem, and has an object to provide a liquid crystal display device and a driving method therefor that are capable of reducing the backlight intensity to reduce power consumption without changing the visual brightness and saturation of the display screen.

In one general aspect, the instant application describes a liquid crystal display device that includes maximum signal detecting section for detecting a maximum signal having a signal level that is maximum among an R signal, a G signal, and a B signal included in an input video signal; correction curve calculating section for calculating a correction curve based on backlight intensity; signal correction value calculating section for calculating, based on the maximum signal and the correction curve, a signal correction value for correcting the input video signal; and signal correcting section for correcting the input video signal based on the signal correction value.

The above general aspect may include one or more of the following features. The correction curve may comprise a quadratic curve that indicates a relationship between an input value and an output value in a coordinate plane. The quadratic curve may have a maximum output value when the signal level as the input value is 50%, and have an output value of 1 when the signal level is 0% and 100%.

The correction curve calculating section may calculate the correction curve based on a PWM signal supplied from outside.

The following relationship may be satisfied,

Y=(A/B)×X,

where A and B represent the backlight intensity, and X and Y represent a maximum output value of the correction curve corresponding to backlight intensity of A and B respectively.

The signal correction value calculating section may set the signal level of the maximum signal in the correction curve as the input value, and may calculate the output value with respect to the input value as the signal correction value.

The signal correcting section may multiply each of the R signal, the G signal, and the B signal by the signal correction value.

In a luminance region with luminance of 50% or less with respect to maximum display luminance, display luminance displayed by the corrected input video signal may be equal to display luminance displayed by the input video signal.

The liquid crystal display device may be configured to have a low power mode of reducing the backlight intensity. The low power mode is set by an instruction of a user.

The liquid crystal display device may be configured to have a low power mode of reducing the backlight intensity. The low power mode maybe set when outside light illuminance falls below a reference value set in advance.

In another general aspect, driving method for a liquid crystal display device of the instant includes that detecting a maximum signal having a signal level that is maximum among an R signal, a G signal, and a B signal included in an input video signal; calculating a correction curve based on backlight intensity; calculating, based on the maximum signal and the correction curve, a signal correction value for correcting the input video signal; and correcting the input video signal based on the signal correction value.

### BRIEF DESCRIPTION OF THE DRAWINGS

FIG. 1 is a view illustrating a schematic configuration of a liquid crystal display device according to an embodiment of the present application.

FIG. 2 is a graph showing an example of a correction curve.

FIG. 3 is a graph showing an example of signal levels of video signals (R signal, G signal, and B signal).

FIG. 4 is a graph showing a correction curve (a).

FIG. 5A is a graph showing a state of change of a signal level of a input signal (video signal).

FIG. 5B is a graph showing the correction curve (a).

FIG. 5C is a graph showing change of the signal level of a output signal obtained by multiplying the input signal of FIG. 5A by the signal correction value of the correction curve (a) of FIG. 5B.

### DETAILED DESCRIPTION

An embodiment of the present application is described below with reference to the drawings.

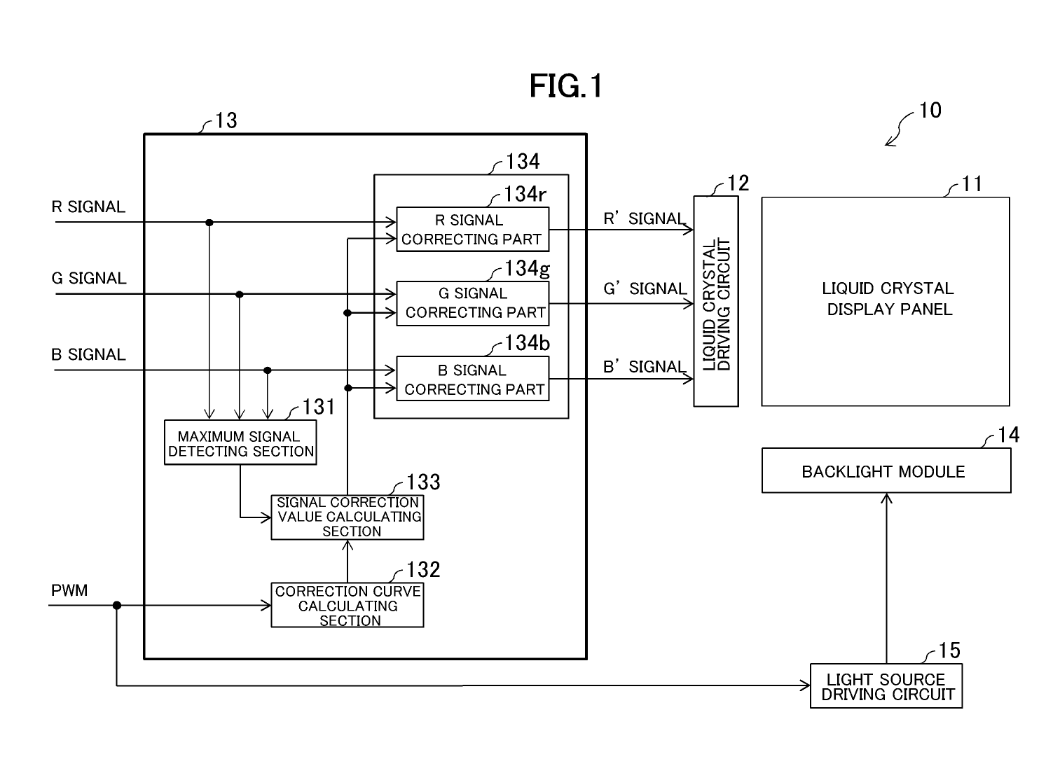

FIG. 1 is a diagram illustrating a schematic configuration of a liquid crystal display device according to an embodiment of the present application. A liquid crystal display device 10 includes a liquid crystal display panel 11, a liquid crystal driving circuit 12 for driving the liquid crystal display panel 11, a display control circuit 13 for controlling the liquid crystal driving circuit 12, a backlight module 14 for irradiating the liquid crystal display panel 11 with light, and a light source driving circuit 15 for driving the backlight module 14.

The display control circuit 13 includes a maximum signal detecting section 131 (maximum signal detecting means), a correction curve calculating section 132 (correction curve calculating means), a signal correction value calculating section 133 (signal correction value calculating means), and a signal correcting section 134 (signal correcting means). Further, the signal correcting section 134 includes, correspondingly to video signals (R signal, G signal, and B signal), an R signal correcting part 134r, a G signal correcting part 134g, and a B signal correcting part 134b.

The display control circuit 13 inputs 8-bit video signals (R signal, G signal, and B signal) in an RGB mode from an external signal source (not shown). The video signals are input to the maximum signal detecting section 131 and the signal correcting section 134 of the display control circuit 13.

Further, the display control circuit 13 inputs a pulse width modulation (PWM) signal from the outside. The duty cycle of the PWM signal (ratio between on-time period and off-time period) is determined depending on a power mode (normal mode or low power mode) set by a user. For example, when the user sets the power mode to the low power mode, the duty cycle of the PWM signal is set to 80%. The backlight intensity corresponds to the duty cycle of the PWM signal, and when the duty cycle is 80%, the backlight intensity is 80%. Note that, the duty cycle of the PWM signal is not particularly limited, and may be set to an arbitrary value by the user. Alternatively, a plurality of stages (levels) maybe set in advance, and the user may select an arbitrary level.

The maximum signal detecting section 131 detects a signal having the maximum signal level (maximum signal) among the video signals (R signal, G signal, and B signal) input from the external signal source. The maximum signal detecting section 131 outputs the detected maximum signal (R signal, G signal, or B signal) to the signal correction value calculating section 133.

The correction curve calculating section 132 calculates a correction curve based on the PWM signal input from the outside. In this case, the correction curve is a quadratic curve graph indicating the relationship between an input value (input signal level) and an output value (correction value) in an XY coordinate plane. Further, the correction curve calculating section 132 calculates a quadratic curve (correction curve) which has the maximum (peak) output value (correction value) when the signal level of the input signal is 50%, and has an output value of 1 when the signal level of the input signal is 0% and 100%. The maximum output value is determined in accordance with the backlight intensity. Specifically, the above-mentioned maximum output value is obtained by the following expression (1).

(Maximum output value)=100(%)/(Backlight intensity) (%) (1)

For example, when the backlight intensity is 80% (duty cycle of the PWM. signal is 80%), the above-mentioned maximum output value is 100(%)/80(%)=1.25.

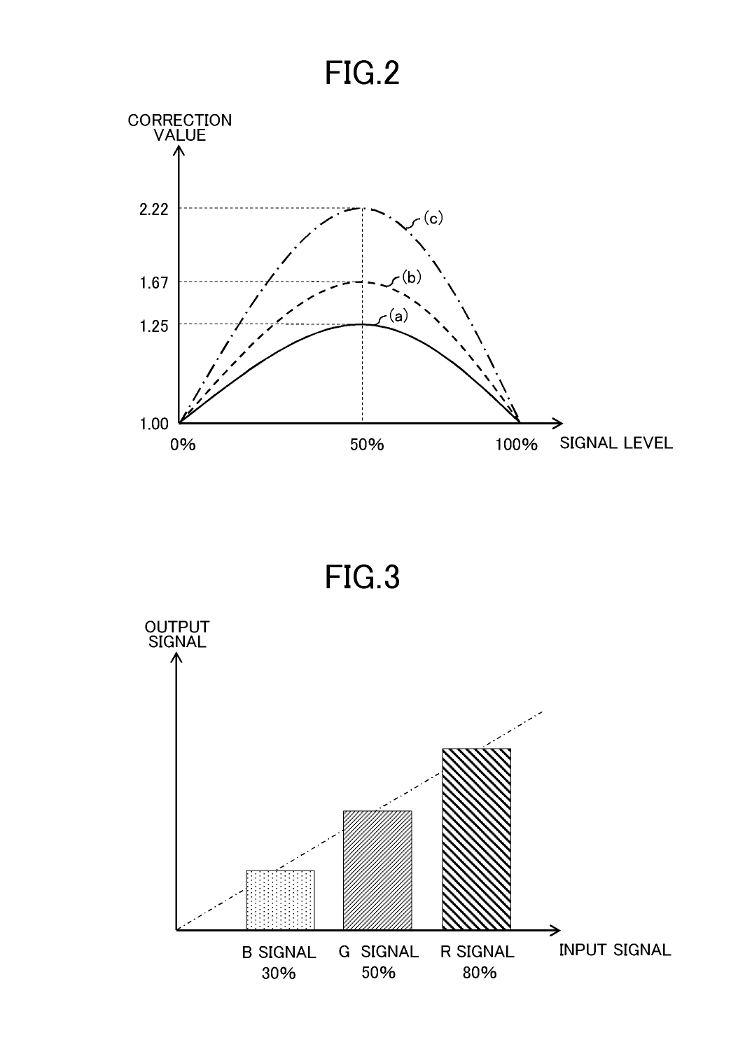

With this, the correction curve calculating section 132 calculates the correction curve that has the maximum output value of 1.25 when the signal level of the input signal is 50%. FIG. 2 is a graph showing an example of the correction curve.

A correction curve (a) indicates a case where the backlight intensity is 80% (maximum output value=1.25), a correction curve (b) indicates a case where the backlight intensity is 60% (maximum output value=1.67), and a correction curve (c) indicates a case where the backlight intensity is 45% (maximum output value=2.22).

Further, the maximum output value of the correction curve has the following relationship. That is, when the backlight intensities are A and B and the maximum output values of the correction curves corresponding to the respective backlight intensities A and B are X and Y, the relationship of Y=(A/B)×X is satisfied.

As described above, the correction curve calculating section 132 calculates the correction curve in accordance with the backlight intensity. The correction curve calculating section 132 outputs the calculated correction curve to the signal correction value calculating section 133.

After the signal correction value calculating section 133 acquires the maximum signal (R signal, G signal, or B signal) detected by the maximum signal detecting section 131 and the correction curve calculated by the correction curve calculating section 132, the signal correction value calculating section 133 calculates a signal correction value based on those maximum signal and correction curve. Specifically, the signal correction value calculating section 133 calculates, as the signal correction value, a correction value corresponding to the signal level of the above-mentioned maximum signal in the above-mentioned correction curve. The signal correction value calculating section 133 outputs the calculated signal correction value to each of the R signal correcting part 134r, the G signal correcting part 134g, and the B signal correcting part 134b of the signal correcting section 134.

The signal correcting section 134 corrects the video signals supplied from the outside by the signal correction value acquired from the signal correction value calculating section 133. Specifically, the R signal correcting part 134r corrects the R signal input from the outside by the signal correction value acquired from the signal correction value calculating section 133, and outputs a corrected R′ signal to the liquid crystal driving circuit 12. The G signal correcting part 134g corrects the G signal input from the outside by the signal correction value acquired from the signal correction value calculating section 133, and outputs a corrected G′ signal to the liquid crystal driving circuit 12. The B signal correcting part 134b corrects the B signal input from the outside by the signal correction value acquired from the signal correction value calculating section 133, and outputs a corrected B′ signal to the liquid crystal driving circuit 12. More specifically, the signal correcting sections 134r, 134g, and 134b multiply the signal levels of the R signal, the G signal, and the B signal by the signal correction value to calculate the R′ signal, the G′ signal, and the B′ signal, respectively.

Note that, although not illustrated, the display control circuit 13 inputs, from an external signal source, horizontal synchronization signals and vertical synchronization signals corresponding to the above-mentioned video signals (R signal, G signal, and B signal), and a control signal for controlling the display operation. Further, the display control circuit 13 generates and outputs, based on those input signals, a data start pulse signal, a data clock signal, a gate start pulse signal, a gate clock signal, a gate driver output control signal, and the like as signals for displaying an image represented by the above-mentioned video signals (R signal, G signal, and B signal) on the liquid crystal display panel 11, in addition to the above-mentioned corrected video signals (R′ signal, G′ signal, and B′ signal).

The liquid crystal driving circuit 12 performs image display processing based on the video signals (R′ signal, G′ signal, and B′ signal) corrected by the signal correcting section 134 and the above-mentioned control signal and the like.

The backlight module 14 is an illumination device for irradiating the liquid crystal display panel 11 with light from the back side, and includes, for example, a plurality of LEDs. The light source driving circuit 15 controls the drive of the backlight module 14 based on the PWM signal input from the outside (PWM control).

Known configurations may be applied to a source driver and agate driver forming the liquid crystal driving circuit 12. Further, although not illustrated, the liquid crystal display panel 11 includes a plurality of source lines driven by the source driver, a plurality of gate lines driven by the gate driver, transistors (TFTs) formed at intersecting portions of the respective source lines and gate lines, and a plurality of pixels arranged in matrix. A known technology may be applied to the image display processing.

With the above-mentioned configuration of the liquid crystal display device 10, an image is displayed based on the corrected video signals that compensate for the reduced amount of luminance caused by the reduction of the backlight intensity.

Next, a specific configuration for correcting the above-mentioned video signals in the display control circuit 13 is described with an example.

FIG. 3 is a graph showing an example of signal levels of video signals (R signal, G signal, and B signal) serving as input signals. FIG. 3 shows a case where the signal level of the R signal is 80%, the signal level of the G signal is 50%, and the signal level of the B signal is 30%. Further, a case where a user sets a power mode to the low power mode so that the backlight intensity is set to 80% is taken as an example.

First, in response to input of the video signals (R signal, G signal, and B signal) to the display control circuit 13, the maximum signal detecting section 131 detects a signal having the maximum signal level (maximum signal) among the R signal, the G signal, and the B signal. In this case, the maximum signal detecting section 131 detects the R signal having the signal level of 80% as the maximum signal. The maximum signal detecting section 131 outputs the detected R signal to the signal correction value calculating section 133.

Further, in response to input of a PWM signal (duty cycle of 80%) corresponding to backlight intensity of 80% to the display control circuit 13, the correction curve calculating section 132 calculates the maximum output value of 1.25 based on the above-mentioned expression (1). Then, the correction curve calculating section 132 calculates the correction curve (a) of FIG. 2.

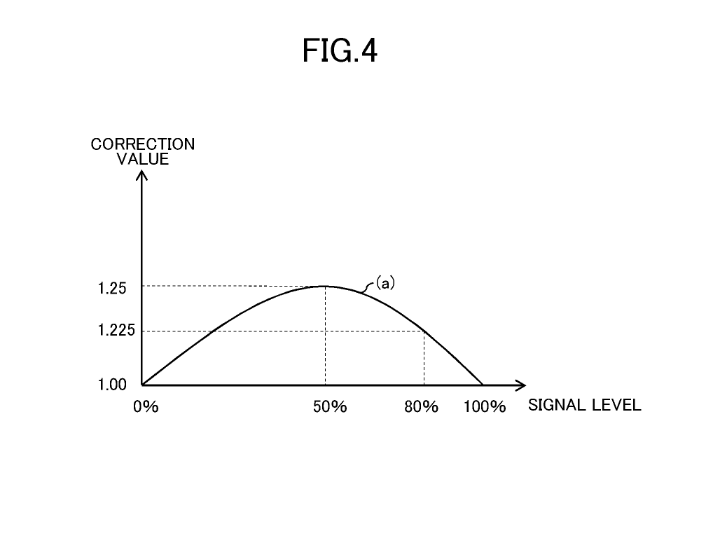

Next, in response to input of the R signal detected by the maximum signal detecting section 131 and the correction curve (a) calculated by the correction curve calculating section 132 to the signal correction value calculating section 133, the signal correction value calculating section 133 calculates the signal correction value based on the R signal and the correction curve (a). In this case, the signal correction value calculating section 133 calculates, as the signal correction value, a correction value of 1.225 that corresponds to the signal level of 80% in the correction curve (a) as shown in FIG. 4.

Next, in response to input of the signal correction value of 1.225 calculated by the signal correction value calculating section 133 to the signal correcting section 134 (each of the R signal correcting part 134r, the G signal correcting part 134g, and the B signal correcting part 134b), the signal correcting section 134 multiplies each of the signal levels of the video signals (R signal, G signal, and B signal) input from the outside by the signal correction value of 1.225, to thereby generate the corrected video signals (R′ signal, G′ signal, and B′ signal). In this case, the R signal correcting part 134r multiplies the signal level of 80% of the R signal by the signal correction value of 1.225 to generate the R′ signal having a signal level of 98%. The G signal correcting part 134g multiplies the signal level of 50% of the G signal by the signal correction value of 1.225 to generate the G′ signal having a signal level of 61.25%. The B signal correcting part 134b multiplies the signal level of 30% of the B signal by the signal correction value of 1.225 to generate the B′ signal having a signal level of 36.75%.

The signal correcting section 134 outputs the corrected R′ signal (signal level of 98%), G′ signal (signal level of 61.25%) and B′ signal (signal level of 36.75%) to the liquid crystal driving circuit 12.

In the example described above, an image is displayed by video signals each having a signal level of 1.225 times as large as the signal level of the input video signal, and hence the luminance is increased by 22.5%. Therefore, it is possible to compensate for the reduced amount of luminance (20%) that is caused by setting the backlight intensity to 80%, and thus possible to prevent reduction in displayed (visual) luminance (display luminance).

Further, the maximum signal having the maximum signal level among the R signal, the G signal, and the B signal is corrected with use of the correction curve that has the maximum output value when the signal level is 50%. Therefore, so-called white saturation in which the luminance is saturated to the maximum level (256 levels) is less caused.

Further, the ratio of the respective signal levels of the RGB signals as an input video signal is equal to the ratio of the respective signal levels of the RGB signals as a corrected video signal, and hence change in saturation (visual hue) can be prevented. Specifically, the ratio of the respective signal levels of the RGB signals as an input video signal is R:G:B=80%:50%:30%=1:0.625:0.375, while the ratio of the respective signal levels of the RGB signals as a corrected video signal is R:G:B=98%:61.25%:36.75%=1:0.625:0.375. Thus, the ratios of both of the RGB signal levels are the same.

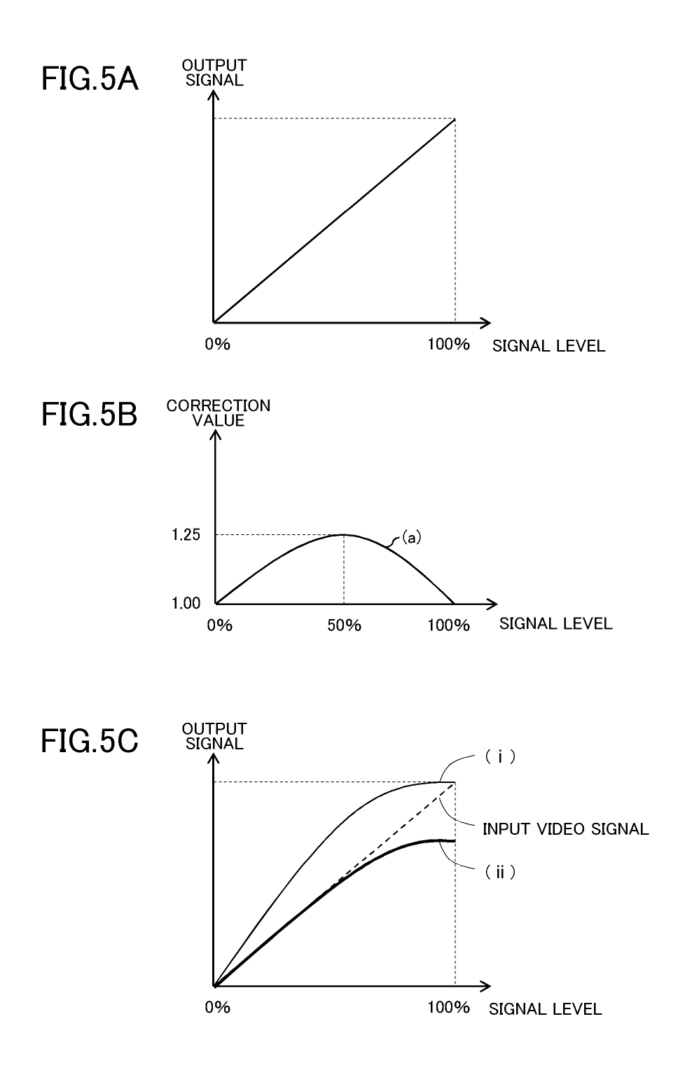

FIGS. 5A to 5C show states of change between a signal level of an input video signal and a signal level of a corrected video signal. FIG. 5A shows a state of change of the signal level of the input signal (video signal), and FIG. 5B shows the correction curve (a). FIG. 5C shows change of the signal level of the output signal obtained by multiplying the input signal of FIG. 5A by the signal correction value of the correction curve (a) of FIG. 5B. Further, in FIG. 5C, a graph (i) indicates a case where the backlight intensity is 100%, and a graph (ii) indicates a case where the backlight intensity is 80%.

As shown in the graph (ii) of FIG. 5C, from a low luminance range to a middle luminance range, the signal level of the output signal is substantially equal to the signal level of the input signal. That is, in a luminance range (from the low luminance range to the middle luminance range) with luminance of 50% or less with respect to the maximum display luminance, the display luminance displayed by the corrected video signals is equal to the display luminance displayed by the input video signals. Thus, the contrast feeling can be maintained.

In the example described above, the case where the R signal has the maximum signal level among the R signal, the G signal, and the B signal included in the input video signal is described, but the present application is not limited thereto. The signal having the maximum signal level differs depending on an image to be displayed, and may be the G signal or the B signal. Further, the above-mentioned correction processing to the video signals is performed for each pixel.

Further, in the example described above, the case where the backlight intensity is set in accordance with the user's selection of the power mode, but the setting of the backlight intensity is not limited thereto. For example, the liquid crystal display device 10 may include a sensor (detection means) for detecting outside light, and the backlight intensity may be automatically set in accordance with the outside light illuminance detected by the sensor. For example, when the outside light illuminance falls below a reference value (threshold value) set in advance, the power mode may be switched to the low power mode to reduce the backlight intensity.

According to the liquid crystal display device and the driving method therefor of the above-mentioned embodiment, the ratio of the respective signal levels of the corrected RGB signals that compensate for the reduced amount of the backlight intensity may be set equal to the ratio of the signal levels of the input video signal. Therefore, the backlight intensity can be reduced to reduce the power consumption without changing the visual brightness and saturation of the display screen.

While there have been described what are at present considered to be certain embodiments of the application, it will be understood that various modifications may be made thereto, and it is intended that the appended claims cover all such modifications as fall within the true spirit and scope of the invention.

What is claimed is:

1. A liquid crystal display device, comprising:
maximum signal detecting section for detecting a maximum signal having a signal level that is maximum among an R signal, a G signal, and a B signal included in an input video signal;
correction curve calculating section for calculating a correction curve based on backlight intensity;
signal correction value calculating section for calculating, based on the maximum signal and the correction curve, a signal correction value for correcting the input video signal; and
signal correcting section for correcting the input video signal based on the signal correction value.

2. The liquid crystal display device according to claim 1, wherein the correction curve comprises a quadratic curve that indicates a relationship between an input value and an output value in a coordinate plane, the quadratic curve having a maximum output value when the signal level as the input value is 50%, and having an output value of 1 when the signal level is 0% and 100%.

3. The liquid crystal display device according to claim 1, wherein the correction curve calculating section calculates the correction curve based on a PWM signal supplied from outside.

4. The liquid crystal display device according to claim 1, wherein the following relationship is satisfied,
Y=(A/B)×X,
where A and B represent the backlight intensity, and X and Y represent a maximum output value of the correction curve corresponding to backlight intensity of A and B respectively.

5. The liquid crystal display device according to claim 2, wherein the signal correction value calculating section sets the signal level of the maximum signal in the correction curve as the input value, and calculates the output value with respect to the input value as the signal correction value.

6. The liquid crystal display device according to claim 1, wherein the signal correcting section multiplies each of the R signal, the G signal, and the B signal by the signal correction value.

7. The liquid crystal display device according to claim 1, wherein, in a luminance region with luminance of 50% or less with respect to maximum display luminance, display luminance displayed by the corrected input video signal is equal to display luminance displayed by the input video signal.

8. The liquid crystal display device according to claim 1,
wherein the liquid crystal display device is configured to have a low power mode of reducing the backlight intensity, and
wherein the low power mode is set by an instruction of a user.

9. The liquid crystal display device according to claim 1,
wherein the liquid crystal display device is configured to have a low power mode of reducing the backlight intensity, and
wherein the low power mode is set when outside light illuminance falls below a reference value set in advance.

10. A driving method for a liquid crystal display device, comprising:
detecting a maximum signal having a signal level that is maximum among an R signal, a G signal, and a B signal included in an input video signal;
calculating a correction curve based on backlight intensity;
calculating, based on the maximum signal and the correction curve, a signal correction value for correcting the input video signal; and
correcting the input video signal based on the signal correction value.
